(19) United States
(12) Patent Application Publication
(10) Pub. No.: US 2010/0229608 A1
(43) Pub. Date: Sep. 16, 2010

(54) Ratchet strap handcuff connectors

(75) Inventors: John A. Dapkins, JR., Bloomsbury, NJ (US); Nicholas I. Klementowicz, III, Hillsborough, NJ (US); Kenneth P. Glynn, Flemington, NJ (US)

Correspondence Address: Kenneth P. Glynn, 24 Mine Street, Flemington, NJ, 08822, US

(73) Assignee: Jersey Tactical Corp.

(21) Appl. No.: 12/381,235

(22) Filed: Mar. 10, 2009

(51) Int. Cl. E05B 75/00; A44B 21/00

(52) U.S. Cl. 70/16; 24/265 R

(57) ABSTRACT

A ratchet strap handcuff connector includes an elongated main member having a first ratchet strap locking head facing a first direction and at least a second ratchet strap locking head facing a direction opposite the first direction. A ratchet strap handcuff connector system includes a) an elongated main member having a first ratchet strap locking head facing a first direction and at least a second ratchet strap locking head facing a direction opposite the first direction; and, b) at least one ratchet strap handcuff having a ratchet strap adapted to fit into a ratchet strap locking head of the elongated member.

### BACKGROUND OF INVENTION

a. Field of Invention

The invention relates generally to handcuff connectors that may be necessary when situations require criminals, prisoners, protestors or other detained groups to be controlled. For example, six officers may arrest and cuff thirty destructive, intoxicated, window-breaking spring break rioting students with flexible ratchet type handcuffs, but how do six officers prevent thirty prisoners from running, or how can they be retained with minimal manpower? The present invention connectors and connector systems provide for linking and locking cuffed prisoners so that they may be joined in a chain or chained to a tree or guardrail or otherwise limited or restrained until significant or appropriate personnel arrive to handle and jail, file or disperse, as required.

b. Description of Related Art

The following patents are representative of the field pertaining to the present invention:

U.S. Pat. No. 5,797,404 to Stanchin, II describes a disposable handcuff providing a two loop expandable strap restraint for law enforcement formed from a continuous single foldable strap that is light weight, strong, inexpensive, disposable, and can be formed of readily available and readily obtainable materials.

U.S. Pat. No. 5,088,158 to Burkholder describes a restraining method that employs apparatus that has a body portion and two, laterally-spaced, downwardly extending flexible straps that can be looped around in opposite directions to be lockingly received by a toothed ratcheting mechanism in corresponding laterally-spaced openings of the body portion. An upwardly extending tab has an opening through which a rope can be strung to link together several restrained prisoners. Strap teeth and tab are located in limb noncontacting positions. The straps bend double about self-hinges with free ends fitting within non-ratcheted loops for pocket storage.

U.S. Pat. No. 4,910,831 to Bingold describes a positive, secure two-loop restraint for law enforcement is light-weight, strong, inexpensive and disposable and which may be attached to the wrists or ankles to be used in place of traditional handcuffs. The restraint is formed from a single elongated, substantially flat plastic strap having a pair of closely spaced socket clasps centrally located therein generally mid-way between first and second strap extremities. The extremities are insertable through openings in the socket clasps which are perpendicular to the plane of the strap and when receiving the extremities form double loops with the strap ends extending parallel to each other when the loops are formed by positioning the extremities through the socket clasps. Each of the extremities has a toothed surface whose teeth all slope in the same direction, and each socket includes a latch stop extending in the same direction as the slope of the teeth for permitting the stop to ride over the teeth during insertion movement and preventing extraction movement, thereby providing a flat ratchet arrangement such that a two-loop restraint is provided, with the sizes of the loops being adjustable in the same direction and which are formed and positioned on wrists or ankles of the restrained person when the extremities are inserted in the same direction through the socket clasps. The straps are made of a high density plastic, are light-weight and a large number may be conveniently carried by a law enforcement user as contrasted with bulky, expensive, heavy and difficult to use handcuffs.

U.S. Pat. No. 366,733 to Stanchin describes FIG. 1 is a perspective view of a handcuff showing my new design; FIG. 2 is a elevational left end view thereof; FIG. 3 is 'levational right end view thereof; FIG. 4 is top plan view thereof; FIG. 5 is a front elevational view, the rear being a mirror image thereof; and, FIG. 6 is a bottom plan view thereof.

U.S. Pat. No. 4,071,023 to Gregory describes a restraining device having an elongated body portion and a pair of arms extending outwardly from the body portion. Each of the arms of such position on the body portion and of such length as to cooperate with on end of the body portion in establishing a closed loop. Locking means, which may be adjustable, are provided for resisting opening of the loop. The restraining device may be of unitary construction and may be molded as a unit from a material such as a resinous plastic.

Notwithstanding the prior art, the present invention is neither taught nor rendered obvious thereby.

### SUMMARY OF INVENTION

The present invention is a ratchet strap handcuff connector that includes an elongated main member having a first ratchet strap locking head facing a first direction and at least a second ratchet strap locking head facing a direction opposite the first direction.

In some preferred embodiments of the present invention ratchet strap handcuff connector, the elongated member is a rigid elongated member.

In some preferred embodiments of the present invention ratchet strap handcuff connector, the elongated member is a flexible elongated member.

In some preferred embodiments of the present invention ratchet strap handcuff connector, the elongated member is selected from the group consisting of a metal member, a plastic member, a composite material member and combinations thereof.

In some preferred embodiments of the present invention ratchet strap handcuff connector, the elongated member is made of a material selected from the group consisting of high density polyethylene, nylon, polyvinyl chloride, a composite material containing graphite fibers and combinations thereof.

In some preferred embodiments of the present invention ratchet strap handcuff connector, the elongated main member includes at least one non-parallel branch extending therefrom and the branch has at least one functional component selected from the group consisting of a loop, a handle, a ratchet strap locking head and a slip-stop.

In some preferred embodiments of the present invention ratchet strap handcuff connector, the elongated main member has a plurality of non-parallel branches extending therefrom and each branch has at least one functional component selected from the group consisting of a loop, a handle, a ratchet strap locking head and a slip-stop.

In some other preferred embodiments, the present invention is a ratchet strap handcuff connector system that includes a) an elongated main member having a first ratchet strap locking head facing a first direction and at least a second ratchet strap locking head facing a direction opposite the first direction; and, b) at least one ratchet strap handcuff having a ratchet strap adapted to fit into a ratchet strap locking head of the elongated member.

In some preferred embodiments of the present invention ratchet strap handcuff connector system, there are a plurality of ratchet strap handcuffs, each of the plurality of ratchet strap handcuffs having a ratchet strap adapted to fit into a ratchet strap locking head of the elongated member.

In some preferred embodiments of the present invention ratchet strap handcuff connector system, the elongated member is a rigid elongated member.

In some preferred embodiments of the present invention ratchet strap handcuff connector system, the elongated member is a flexible elongated member.

In some preferred embodiments of the present invention ratchet strap handcuff connector system, the elongated member is selected from the group consisting of a metal member, a plastic member, a composite material member and combinations thereof.

In some preferred embodiments of the present invention ratchet strap handcuff connector system, the elongated member is made of a material selected from the group consisting of high density polyethylene, nylon, polyvinyl chloride, a composite material containing graphite fibers and combinations thereof.

In some preferred embodiments of the present invention ratchet strap handcuff connector system, the elongated main member includes at least one non-parallel branch extending therefrom and the branch has at least one functional component selected from the group consisting of a loop, a handle, a ratchet strap locking head and a slip-stop.

In some preferred embodiments of the present invention ratchet strap handcuff connector system, there are a plurality of ratchet strap handcuff having a ratchet strap adapted to fit into a ratchet strap locking head of the elongated member.

In some preferred embodiments of the present invention ratchet strap handcuff connector system, the elongated main member has a plurality of non-parallel branches extending therefrom and each branch has at least one functional component selected from the group consisting of a loop, a handle, a ratchet strap locking head and a slip-stop.

In some preferred embodiments of the present invention ratchet strap handcuff connector system, the elongated main member has a plurality of non-parallel branches extending therefrom and each branch has at least one functional component selected from the group consisting of a loop, a handle, a ratchet strap locking head and a slip-stop.

In some preferred embodiments of the present invention ratchet strap handcuff connector system, a plurality of non-parallel branches includes at least one ratchet strap locking head.

In some preferred embodiments of the present invention ratchet strap handcuff connector system, the elongated member has opposing ends with a first end having a ratchet strap locking head and a second end having a ratchet strap adapted to fit into and lock in the ratchet strap locking head of the first end.

In some preferred embodiments of the present invention ratchet strap handcuff connector system, there are a plurality of elongated members connected

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detail description serve to explain the principles of the invention. In the drawings:

FIG. 1 shows a side view of a present invention ratchet strap handcuff connector system that includes a connector and two different types of ratchet strap handcuff;

FIG. 2 shows a top view of present invention ratchet strap handcuff connector system shown in FIG. 1;

FIG. 3 shows a partial side cut view of a present invention ratchet strap handcuff connector locking head with a ratchet strap handcuff inserted and locked therein;

FIG. 4 shows a top view of a different embodiment of a present invention ratchet strap handcuff connector having plural connector interconnection capabilities;

FIG. 5 shows a top view of a third embodiment of present invention ratchet strap handcuff connector; and,

FIG. 6 shows a top view of the forth embodiment of a present invention ratchet strap handcuff connector.

### DETAILED DESCRIPTION OF THE EMBODIMENTS

The present invention is both a handcuff connector and a handcuff connector system utilizing one or more connectors and one or more handcuffs in combination.

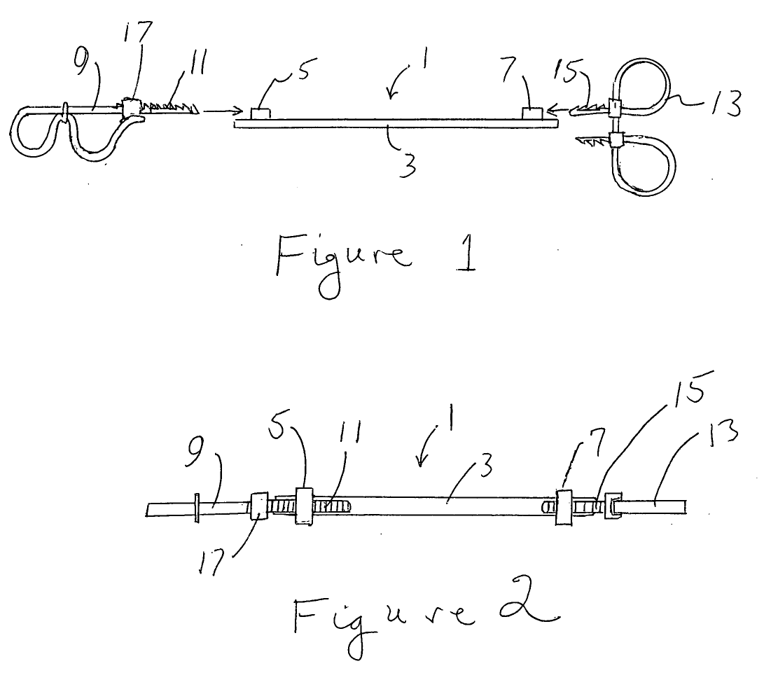

FIG. 1 illustrates a side view of a present invention ratchet strap handcuff connector system 1. System 1 includes a present invention ratchet strap handcuff connector 3. In this embodiment ratchet strap handcuff connector 3 has an elongated main member with opposing ends with opposite facing first ratchet strap locking head 5 and second ratchet strap locking head 7. To illustrate the versatility of present invention connectors and systems, FIG. 1 also shows two different types of flexible handcuffs 9 and 13 about to be inserted into the locking heads of connector 3.

More specifically, handcuff 11 has a single locking head 17 with locking ratchets 11 extending therethrough, whereas handcuff 13 has two separate locking ratchets and sets of locking heads extending separately therethrough. Thus locking ratchets 15 from handcuff 13 and locking ratchets 11 from handcuff 9 may respectively be inserted and locked into connector locking heads 5 and 7 so as to link and lock two cuffed persons together via connector 3.

FIG. 2 shows a top view of connector system 1 shown above in FIG. 1, except that the handcuffs 9 and 13 are already inserted into locking heads 5 and 7. Please note that the present invention system connector 3 elongated main member has locking heads that receive ratchet straps in parallel to the elongation of connector 3. However, the angles of the locking heads may be parallel to, at right angles to, or otherwise angled with respect to the elongation of the connector, without exceeding the scope of the present invention.

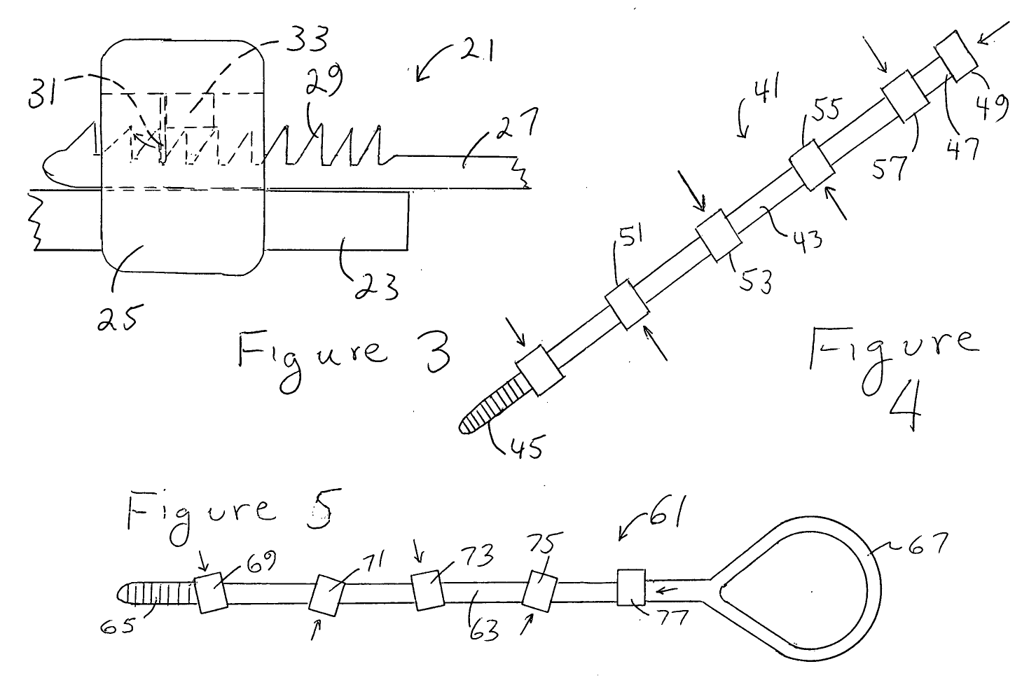

FIG. 3 shows a partial side cut view of a present invention ratchet strap handcuff connector locking head with a ratchet strap handcuff inserted and locked therein to show some of the details of the possible internal aspects of the locking heads used in the embodiments shown above and below. Not all ratchet heads have the same internals as shown here and the present invention may use any available internal mechanism to lock the ratchets. Here, present invention system 21, includes connector 23 with a ratchet locking head 25 and with guide 33 and plastic or metal tab 31. Tab 31 will flex to the right to permit insertion of a ratchet cuff end, but will not flex to the left, preventing an inserted ratchet cuff end from being removed. Thus, cuff 27, shown partially at a ratchet end, has one way ratchets 29 that are inserted into locking head 25.

FIG. 4 shows a top view of a different embodiment of a present invention ratchet strap handcuff connector 41 having an elongated main member 43, and having ends 45 and 49 that are adapted for plural connector interconnection capabilities. Thus, if two or more connectors 41 were lined up, end 45 of one connector could be irreversibly inserted into end 49 of the next connector to make it as long as desired within reason. This could accommodate a larger number of prisoners or would provide sufficient length to chain to a tree or other fixed structure. Also, in this embodiment, the individual locking heads 51, 53, 55 and 57 are at right angles to the elongation of the main member 43 and are sequentially open to opposite sides of the main member 43 (as shown by the straight arrows indicating ratchet cuff insertion direction).

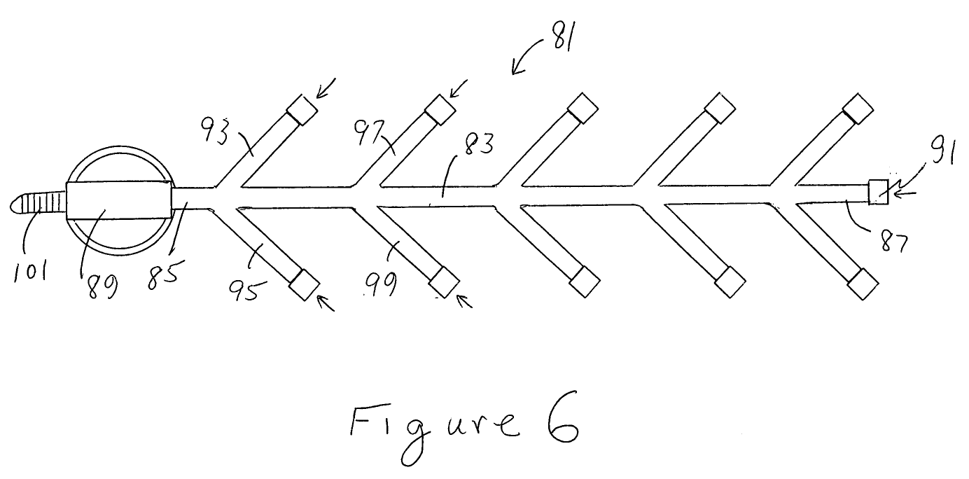

FIG. 5 shows a top view of a third embodiment of present invention ratchet strap handcuff connector; here connector 61. In this embodiment, the connector 61 has a plurality of opposing ratchet locking heads 69, 71, 73, 75 and 77 that are positioned at non-right angles to the elongation of the main member 63. End 65 of elongated member 63 has ratchets so that it can be inserted into another connector of the same kind or a different kind (such as in FIG. 4 above). Opposite end 67 is a looped handle for moving along a collection of prisoners connected by ratchet cuffs to the connector 61. (As is well known in the disposable handcuff field, cutters are used to free prisoners from ratchet cuffs and cutters can also be used to cut away one or more prisoners or to remove a connector from a tree or other fixed object for any connector or system described herein.

FIG. 6 shows a top view of the forth embodiment of a present invention ratchet strap handcuff connector 81. Main member 83 has a plurality of branches exemplified by branches 93, 95, 97 and 99 that each has a ratchet locking head thereon. Main member ends 91 and 101 have ratchet locking head and ratchets thereon for plural connector interconnection, as well as a handle 89, as shown. This particular present invention connector 81 has been laid out to accommodate up to ten prisoners and can be interconnected to accommodate up to twenty by a single interconnection, or lopped to be secured to a fixed object. Alternatively, fewer prisoners may be locked onto present invention connectors by skipping some of the locking heads and creating spacing opportunities between prisoners.

With reference to the accompanying drawings, it is to be understood that the invention is not limited to those particular embodiments, and that various changes and modifications may be effected therein by one skilled in the art without departing from the scope or spirit of the invention as defined herein and in the appended claims. For example, the present invention connectors may be made of the same or different plastics as conventional disposable ratchet cuffs. They may include other materials, such as natural or synthetic components, as well as metal components and they may be flexible, semiflexible or rigid.

What is claimed is:

1. A ratchet strap handcuff connector, which comprises:
an elongated main member having a first ratchet strap locking head facing a first direction and at least a second ratchet strap locking head facing a direction opposite said first direction.

2. The ratchet strap handcuff connector of claim 1 wherein said elongated member is a rigid elongated member.

3. The ratchet strap handcuff connector of claim 1 wherein said elongated member is a flexible elongated member.

4. The ratchet strap handcuff connector of claim 1 wherein said elongated member is selected from the group consisting of a metal member, a plastic member, a composite material member and combinations thereof.

5. The ratchet strap handcuff connector of claim 1 wherein said elongated member is made of a material selected from the group consisting of high density polyethylene, nylon, polyvinyl chloride, a composite material containing graphite fibers and combinations thereof.

6. The ratchet strap handcuff connector of claim 1 wherein said elongated main member includes at least one non-parallel branch extending therefrom and said branch has at least one functional component selected from the group consisting of a loop, a handle, a ratchet strap locking head and a slip-stop.

7. The ratchet strap handcuff connector of claim 1 wherein said elongated main member has a plurality of non-parallel branches extending therefrom and each branch has at least one functional component selected from the group consisting of a loop, a handle, a ratchet strap locking head and a slip-stop.

8. A ratchet strap handcuff connector system, which comprises:
a) an elongated main member having a first ratchet strap locking head facing a first direction and at least a second ratchet strap locking head facing a direction opposite said first direction; and,
b) at least one ratchet strap handcuff having a ratchet strap adapted to fit into a ratchet strap locking head of said elongated member.

9. The ratchet strap handcuff connector system of claim 8 wherein there are a plurality of ratchet strap handcuffs, each of said plurality of ratchet strap handcuffs having a ratchet strap adapted to fit into a ratchet strap locking head of said elongated member.

10. The ratchet strap handcuff connector system of claim 8 wherein said elongated member is a rigid elongated member.

11. The ratchet strap handcuff connector system of claim 8 wherein said elongated member is a flexible elongated member.

12. The ratchet strap handcuff connector system of claim 8 wherein said elongated member is selected from the group consisting of a metal member, a plastic member, a composite material member and combinations thereof.

13. The ratchet strap handcuff connector system of claim 8 wherein said elongated member is made of a material selected from the group consisting of high density polyethylene, nylon, polyvinyl chloride, a composite material containing graphite fibers and combinations thereof.

14. The ratchet strap handcuff connector system of claim 8 wherein said elongated main member includes at least one non-parallel branch extending therefrom and said branch has at least one functional component selected from the group consisting of a loop, a handle, a ratchet strap locking head and a slip-stop.

15. The ratchet strap handcuff connector system of claim 14 wherein there are a plurality of ratchet strap handcuff having a ratchet strap adapted to fit into a ratchet strap locking head of said elongated member.

16. The ratchet strap handcuff connector system of claim 14 wherein said elongated main member has a plurality of non-parallel branches extending therefrom and each branch has at least one functional component selected from the group consisting of a loop, a handle, a ratchet strap locking head and a slip-stop.

17. The ratchet strap handcuff connector system of claim 16 wherein said elongated main member has a plurality of non-parallel branches extending therefrom and each branch has at least one functional component selected from the group consisting of a loop, a handle, a ratchet strap locking head and a slip-stop.

18. The ratchet strap handcuff connector system of claim 16 wherein a plurality of non-parallel branches include at least one ratchet strap locking head.

19. The ratchet strap handcuff connector system of claim 8 wherein said elongated member has opposing ends with a first end having a ratchet strap locking head and a second end having a ratchet strap adapted to fit into and lock in said ratchet strap locking head of said first end.

20. The ratchet strap handcuff connector system of claim 19 wherein there are a plurality of elongated members connected to one another at their opposite ends.
